(19) United States
(12) Patent Application Publication
(10) Pub. No.: US 2013/0223068 A1
(43) Pub. Date: Aug. 29, 2013

(54) LIGHT EMITTING MODULE

(71) Applicant: Sun Yeol Choi, Suwon-si (KR)

(72) Inventor: Sun Yeol Choi, Suwon-si (KR)

(73) Assignee: SAMSUNG ELECTRONICS CO., LTD., Suwon-si, Gyeonggi-do (KR)

(21) Appl. No.: 13/884,433

(22) PCT Filed: Nov. 9, 2011
(86) PCT No.: PCT/KR2011/008490

§ 371 Date: May 9, 2013

(30) Foreign Application Priority Data
Nov. 10, 2010 (KR) 10-2010-0111711

(51) Int. Cl. F21V 23/00

(52) U.S. Cl. CPC F21V 23/001; F21K 9/56
USPC 362/235; 362/249.02; 362/249.06

(57) ABSTRACT

There is provided a light emitting module including: a circuit board having a recess formed in one surface thereof; one or more light emitting elements disposed on the circuit board; and a connector coupled to the recess and electrically connected to the light emitting elements by a wiring pattern formed in the circuit board.

Since a surface mounting technology (SMT) is not used in forming the connector of the light emitting module, process convenience can be enhanced. In addition, the light emitting module having a connecting structure standardized for various types of module can be provided.

### BACKGROUND OF THE INVENTION

1. Field of the Invention

The present invention relates to a light emitting module.

2. Description of the Related Art

A light emitting diode (LED), a type of semiconductor light emitting element, is a semiconductor device capable of generating light of various colors according to the recombination of electrons and holes at p-type semiconductor and n-type semiconductor junctions when current is applied thereto. Compared with a filament-based light emitting element, the light emitting diode has various advantages such as a long lifespan, low power consumption, excellent initial driving characteristics, high vibration resistance, and the like, so demand for the light emitting diode continues to grow. In particular, recently, a group III-nitride semiconductor capable of emitting short-wavelength blue light has come to prominence.

A light source module used for an LCD backlight, or the like, conventionally employs a cold cathode fluorescent lamp (CCFL), however, mercury gas is used therein, having disadvantages in that it has a slow response speed and a low degree of color reproduction (or a small color gamut) and is not suitable for use with light, thin, short, and small LCD panels. In comparison, an LED is eco-friendly, has a fast response speed, within the range of a few nano-seconds, so as to provide a high speed response, and is thus effective for use with a video signal stream, is available for impulsive driving, has a color gamut of 100% or higher, can arbitrarily change luminance, color temperature, or the like, by adjusting the quantity of light emitted by red, green and blue LEDs, and is suitable for a light, thin, short, and small LCD panel. As such, the LED has been actively employed as a backlight light source module.

### SUMMARY OF THE INVENTION

An aspect of the present invention provides a light emitting module in which a connector for receiving an external electrical signal is formed without using surface mounting technology (SMT) and a connecting structure is standardized for various types of module.

According to an aspect of the present invention,

There is provided a light emitting module including: a circuit board having a recess formed in one surface thereof; one or more light emitting elements disposed on the circuit board; and a connector coupled to the recess and electrically connected to the light emitting elements by a wiring pattern formed in the circuit board.

The connector may have terminal portions formed on at least one surface of the recess.

The circuit board may have a bar-like shape, and the connector may be disposed in at least one end of the circuit board in a length direction.

A plurality of light emitting elements may be provided, and the plurality of light emitting elements may be arranged in the length direction of the circuit board.

The terminal portions may be formed on the bottom surface of the recess.

The recess may be formed in an upper surface of the circuit board.

The recess may be formed in at least one lateral surface of the circuit board.

The connector formed by the recess may form a female connector, a male connector may be further formed on the other lateral surface of the circuit board in which the recess is formed, and include protrusion portions protruded from the other lateral surface and terminal portions formed on the protrusion portions.

A plurality of circuit boards may be provided, and female connector and male connector of adjacent circuit boards may be connected to each other.

The light emitting module may further include: a wavelength conversion unit disposed in a path of light emitted from the light emitting element.

The wavelength conversion unit may include a wavelength conversion material and a sealing member hermetically sealing the wavelength conversion material.

The wavelength conversion material may be quantum dots.

A plurality of light emitting elements may be provided, and the wavelength conversion unit may be formed as a single body with respect to the plurality of light emitting elements.

A test terminal for inspecting the light emitting elements may not be provided on the circuit board.

According to another aspect of the present invention,

There is provided a light emitting module including: a circuit board; one or more light emitting elements disposed on the circuit board; and a connector electrically connected to the light emitting elements by a wiring pattern formed in the circuit board and having terminal portions formed on at least one lateral surface of the circuit board.

The lateral surface of the circuit board on which the connector is formed may be flat.

As set forth above, according to embodiments of the invention, since a surface mounting technology (SMT) is not used in forming the connector of the light emitting module, process convenience can be enhanced.

In addition, the light emitting module having a connecting structure standardized for various types of module can be provided.

### BRIEF DESCRIPTION OF THE DRAWINGS

FIGS. 1 through 4 are views illustrating a light emitting module according to an embodiment of the present invention, wherein FIG. 1 is a schematic top plan view of the light emitting module and FIGS. 2 through 4 are schematic perspective views of the light emitting module.

FIG. 5 is a perspective view schematically illustrating a light emitting module according to another embodiment of the present invention;

FIG. 6 is a perspective view schematically illustrating a scheme for connecting light emitting modules of FIG. 5;

FIGS. 7 through 9 are perspective views schematically illustrating a light emitting module according to another embodiment of the present invention;

FIG. 10 is a perspective view schematically illustrating a light emitting module according to another embodiment of the present invention; and

FIG. 11 is a plan view schematically illustrating a backlight unit employing the light emitting module of FIG. 10.

### DETAILED DESCRIPTION OF THE PREFERRED EMBODIMENT

Embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

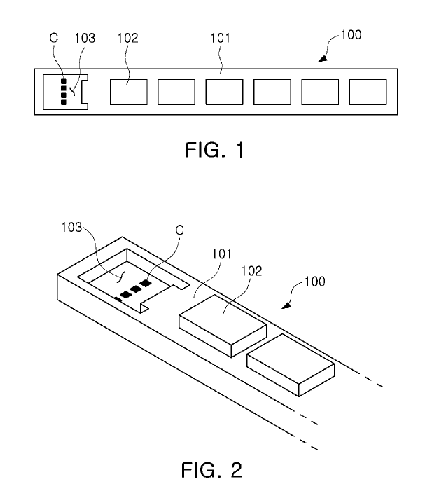

FIGS. 1 through 4 are views illustrating a light emitting module according to an embodiment of the present invention, wherein FIG. 1 is a schematic top plan view of the light emitting module and FIGS. 2 through 4 are schematic perspective views of the light emitting module. Referring to FIGS. 1 through 3, a light emitting module 100 according to an embodiment of the present invention includes a circuit board 101, a light emitting element 102, and a connector 103. The circuit board 101 may have a shape, i.e., a bar-like shape, extending in one direction (i.e., a length direction), and as the circuit board 101, for example, a printed circuit board (PCB), a metal-core

PCB (MCPCB), a metal PCB (MPCB), a flexible PCB (FPCB), or the like, used in the art may be used. In this case, the circuit board 101 may have a wiring pattern (not shown) on a surface or in the interior, or the like, thereof, and the wiring pattern is electrically connected to the light emitting element 102.

The light emitting element 102 may be any element as long as it emits light when an electrical signal is applied thereto. Preferably, a light emitting diode may be used. In the present embodiment, a plurality of light emitting elements 102 may be provided and electrically connected. When the circuit board 101 has a bar-like shape, the plurality of light emitting elements 102 may be arranged in a length direction of the circuit board 101, as illustrated in FIG. 1. In this case, the light emitting elements 102 may be mounted on the circuit board 101 as chips (which has a so-called chip-on-board (COB) structure) or may be packaged to be mounted on the circuit board 101. Namely, there is no limitation in the mounting method. Also, although not shown, the light emitting element 102 may be connected to the wiring pattern of the circuit board 101 by using various methods, e.g., through a conductive wire, flip-chip bonding, and the like.

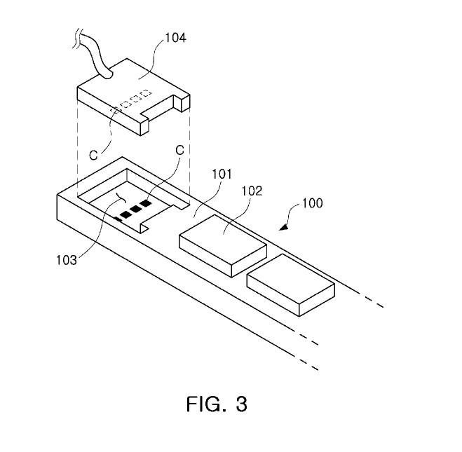

The connector 103 serves to transmit and receive an electrical signal to and from the outside. The connector 103 is provided as a recess-shape formed in an upper surface of the circuit board 101 and electrically connected to the light emitting element 102 by the wiring pattern formed in the circuit board 101. For example, in the present embodiment, as illustrated in FIG. 2, the connector 103 has terminal portions C connected to the wiring pattern of the circuit board 101 and an external electrical signal may be applied by the terminal portions C. In this case, the terminal portions C may be formed on a bottom surface of the recess. Also, in order to ensure an effective connection, the connector 103 may be disposed in the end of the circuit board 101, but not necessarily. Meanwhile, in the present embodiment, the recess has a quadrangular shape with partial protrusion portions in an upper portion thereof in order to enhance bonding strength with an external terminal, i.e., a harness 104 in FIG. 3. However, the recess may not necessarily have such a shape, and in the case of the recess forming the connector 103, it may have a basic quadrangular shape when viewed from above.

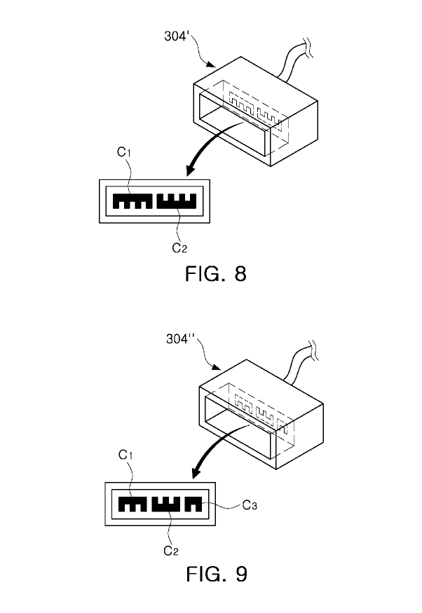

FIG. 3 illustrates how the harness 104 for applying an external electrical signal is connected to the light emitting module 100. The harness 104 may have a shape corresponding to that of the recess of the connector 103, i.e., the shape corresponding to the shape of the recess formed in the circuit board 101 and have terminal portions C connected to the terminal portions C of the connector 103. An electrical signal applied through the terminal portions C of the harness 104 may be transmitted to the light emitting element 102 through the terminal portions C of the connector 103 and the wiring pattern of the circuit board 101. In this case, the number and shape of the terminal portions C provided in the connector 103 and the harness 104 may be appropriately modified as necessary, for example, according to an intended scheme for electrically connecting light emitting elements as described in detail with reference to FIGS. 8 and 9 hereinafter.

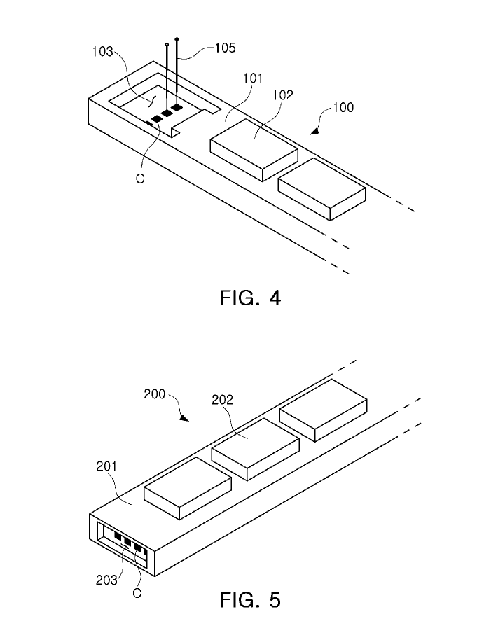

In the present embodiment, the connector 103 may be provided as a recess in the circuit board 101, advantageously eliminating the necessity of using surface mounting technology (SMT) to form a connector. Also, as illustrated in FIG. 4, whether the light emitting element 102 is defective may be inspected by brining a probe 105 into contact with the connector 103, without the necessity of the presence of a test terminal in the circuit board 101. In addition, unlike a connector formed through surface mounting technology as in the related art, the connector 103 may be standardized in shape to allow various types of module to be provided.

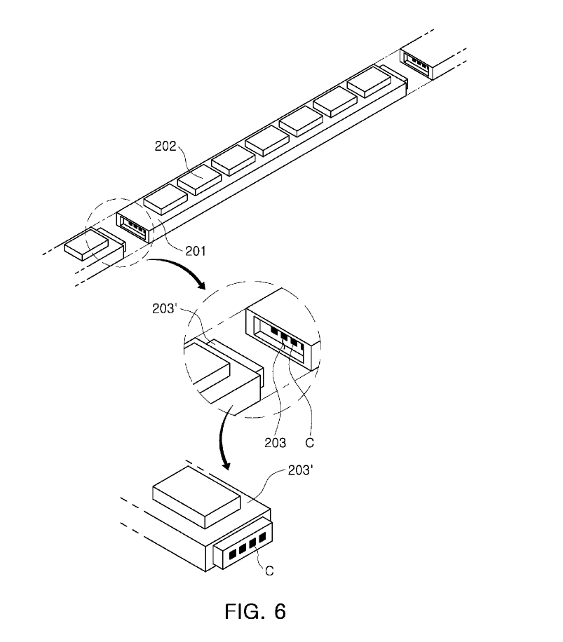

FIG. 5 is a perspective view schematically illustrating a light emitting module according to another embodiment of the present invention. FIG. 6 is a perspective view schematically illustrating a scheme for connecting light emitting modules of FIG. 5. Referring to FIG. 5, like that of the former embodiment, a light emitting module 200 according to the present embodiment has a structure including a circuit board 201, a light emitting element 202, and a connector 203. In this case, however, the connector 203 is disposed on one side of the circuit board 201. Namely, the connector 203 may be formed by forming a recess in a lateral surface of the circuit board 201 and forming terminal portions C on the bottom surface of the recess. In the case of using the connector 203 formed on the lateral surface of the circuit board 201, the number of light emitting elements 202 mounted on the circuit board 201 may be increased, enhancing light emitting performance of the light emitting module 200. Also, as illustrated in FIG. 6, a plurality of light emitting modules 200 may be appropriately connected. In detail, a connector having a recess shape, i.e., a female connector 203, may be formed in one end of the light emitting module and a connector having a portion protruded from a lateral surface of the circuit board 201, i.e., a male connector 203′, may be formed in the other end of the light emitting module. By connecting the female connector 203 and the male connector 203′, a light source having a desired size may be easily implemented.

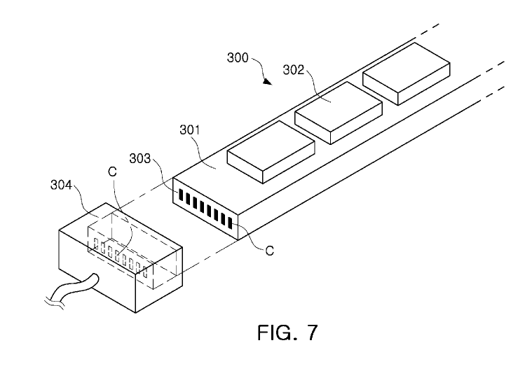

FIGS. 7 through 9 are perspective views schematically illustrating a light emitting module according to another embodiment of the present invention. Referring to FIG. 7, like the embodiment of FIG. 5, a light emitting module 300 according to the present embodiment has a structure including a circuit board 301, a light emitting element 302, and a connector 303, and in this case, the connector 303 is disposed on one lateral surface of the circuit board 301. The connector 303 according to the present embodiment is different from the embodiment of FIG. 5, in that it is not provided as a recess. In detail, the connector 303 is disposed on a lateral surface of the circuit board 301. Namely, since the connector 303 has a structure in which terminal portions C are formed on one flat lateral surface of the circuit board 301, there is no need to form a recess in the circuit board 301. In this case, since the terminal portions C are formed on the flat surface, a harness 304 may have an accommodation recess accommodating the connector 303 and have terminal portions C formed on the bottom surface of the accommodation recess.

Meanwhile, in the case of the present embodiment, the shape of the terminal portions C of the harness 304 may be appropriately modified so as to implement an electrical connection of the light emitting elements 302 provided in the light emitting module 300. In detail, as illustrated in the embodiment of FIG. 8, a harness 304′ may include two separated terminal portions C1 and C2. Unlike the embodiment of FIG. 8, in an embodiment of FIG. 9, a harness 304″ may have three terminal portions C1, C2, and C3. In detail, even in a case in which physical connecting structures of the light emitting elements 302 are the same in the light emitting module 300, the structures may be appropriately modified such that two light emitting elements 302 are electrically connected in parallel (FIG. 8) or three light emitting elements 302 are electrically connected in parallel (FIG. 9). Thus, by differentiating only the wiring patterns of the harness 304′ and 304″ with respect to the same light emitting module 300, electrical connection schemes may be advantageously modified. However, without being limited thereto, the modification of the wiring pattern of the harness may also be applied to the former embodiment.

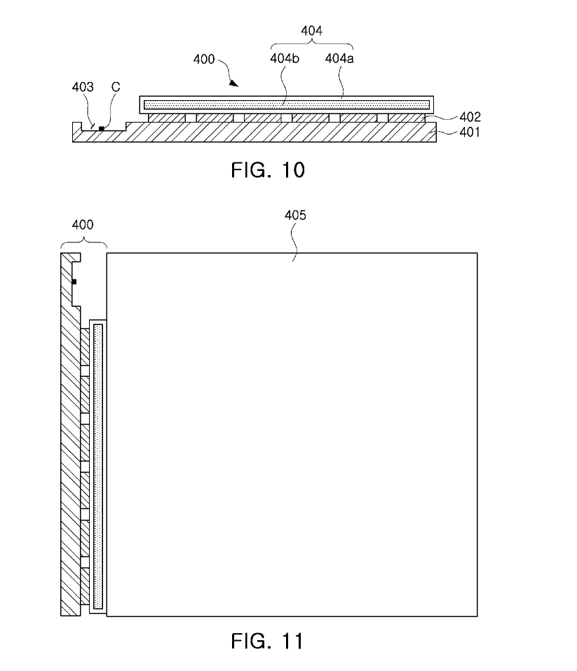

FIG. 10 is a perspective view schematically illustrating a light emitting module according to another embodiment of the present invention. FIG. 11 is a plan view schematically illustrating a backlight unit employing the light emitting module of FIG. 10. Referring to FIG. 10, in the present embodiment, a light emitting module 400 is basically similar to that of the embodiment of FIG. 1. In detail, the light emitting module 400 has a structure including a circuit board 401, light emitting elements 402, and a connector 403. The connector 403 includes a recess formed in an upper surface of the circuit board 401 and a terminal portion C formed on a bottom surface of the recess. In the present embodiment, a wavelength conversion unit 404 is disposed in a path of light emitted from the light emitting elements 402. In this case, the wavelength conversion unit 404 may be disposed above the light emitting elements 402, and in this case, the wavelength conversion unit 404 may be in contact with the light emitting elements 402 as illustrated in FIG. 10 or may be disposed to be spaced apart from the light emitting elements 402. Also, the wavelength conversion unit 404 may be formed as a single body with respect to the plurality of light emitting elements 402.

The wavelength conversion unit 404 may serve to convert a wavelength of light emitted from the light emitting elements 402, whereby the light emitting module 400 may emit white light. In order to perform such a light conversion function, the wavelength conversion unit 404 may have a wavelength conversion material 404b and a sealing member 404a sealing the wavelength conversion material 404b. As the wavelength conversion material 404b, phosphors, quantum dots, or the like, known in the art, may be used. In this case, even when quantum dots vulnerable to oxygen or moisture are used, since the sealing member 404a is provided, reliability can be maintained. In this case, the sealing member 404a may be made of glass or a transparent polymer material appropriate for protecting the wavelength conversion material 404b.

Meanwhile, the light emitting module 400 having the structure of FIG. 10 may have various uses such as in a backlight unit, a lighting device, or the like. For example, in case of a backlight unit, first, the light emitting module 400 of FIG. 10 may be disposed below a liquid crystal display (LCD) device to provide light emitted therefrom to the LCD device (a so-called direct type backlight unit). Alternatively, as illustrated in FIG. 11, the light emitting module 400 may be disposed on a lateral side of a light guide plate 405 and two-dimensional (2D) light which has passed through the light guide plate 405 may be provided to the LCD device (a so-called a side view type backlight unit).

While the present invention has been shown and described in connection with the embodiments, it will be apparent to those skilled in the art that modifications and variations can be made without departing from the spirit and scope of the invention as defined by the appended claims.

While the present invention has been shown and described in connection with the embodiments, it will be apparent to those skilled in the art that modifications and variations can be made without departing from the spirit and scope of the invention as defined by the appended claims.

What is claimed is:

1. A light emitting module comprising:
a circuit board having a recess formed in one surface thereof;
one or more light emitting elements disposed on the circuit board; and
a connector coupled to the recess and electrically connected to the light emitting elements by a wiring pattern formed in the circuit board.

2. The light emitting module of claim 1, wherein the connector has terminal portions formed on at least one surface of the recess.

3. The light emitting module of claim 1, wherein the circuit board has a bar-like shape, and the connector is disposed in at least one end of the circuit board in a length direction.

4. The light emitting module of claim 3, wherein a plurality of light emitting elements are provided, and the plurality of light emitting elements are arranged in the length direction of the circuit board.

5. The light emitting module of claim 2, wherein the terminal portions are formed on a bottom surface of the recess.

6. The light emitting module of claim 1, wherein the recess is formed in an upper surface of the circuit board.

7. The light emitting module of claim 1, wherein the recess is formed in at least one lateral surface of the circuit board.

8. The light emitting module of claim 7, wherein the connector formed by the recess forms a female connector, a male connector is further formed on the other lateral surface of the circuit board in which the recess is formed, and includes protrusion portions protruded from the other surface and terminal portions formed on the protrusion portions.

9. The light emitting module of claim 8, wherein a plurality of circuit boards are provided, and female connectors and male connectors of adjacent circuit boards are connected to each other.

10. The light emitting module of claim 1, further comprising:
a wavelength conversion unit disposed in a path of light emitted from the light emitting element.

11. The light emitting module of claim 10, wherein the wavelength conversion unit includes a wavelength conversion material and a sealing member sealing the wavelength conversion material.

12. The light emitting module of claim 11, wherein the wavelength conversion material is quantum dots.

13. The light emitting module of claim 10, wherein a plurality of light emitting elements are provided, and the wavelength conversion unit is formed as a single body with respect to the plurality of light emitting elements.

14. The light emitting module of claim 1, wherein a test terminal for inspecting the light emitting elements is not provided in the circuit board.

15. A light emitting module comprising:
a circuit board;
one or more light emitting elements disposed on the circuit board; and
a connector electrically connected to the light emitting elements by a wiring pattern formed in the circuit board and having terminal portions formed on at least one lateral surface of the circuit board.

16. The light emitting module of claim 15, wherein the lateral surface of the circuit board on which the connector is formed is flat.
